(19) United States
(12) Patent Application Publication
(10) Pub. No.: US 2005/0122389 A1
(43) Pub. Date: Jun. 9, 2005

(54) Multi-conference stream mixing

(76) Inventor: Kai Miao, Boonion, NJ (US)

Correspondence Address: BUCKLEY, MASCHOFF, TALWALKAR LLC, 5 ELM STREET, NEW CANAAN, CT, 06840, US

(21) Appl. No.: 10/723,413

(22) Filed: Nov. 26, 2003

(51) Int. Cl. H04N 7/14

(52) U.S. Cl. 348/14.01; 348/14.08

(57) ABSTRACT

A system, an apparatus, and a method for mixing multiple conferencing streams using a single mixer.

### BACKGROUND

Remote conferencing includes discussions between at least two people located in at least two different locations and typically involves a group of people in a plurality of locations. Remote conferencing has been performed utilizing a Public Switched Telephone Network (PSTN). Such remote conferencing often was performed using analog video and satellite links and required dedicated circuits on the PSTN so that remote conferencing circuits were unavailable for other users.

Remote conferencing, often called multimedia conferencing when it includes the transmission of video and audio, is increasing in popularity and is conducted not only on telephone networks, but also digital network such as the Internet.

### BRIEF DESCRIPTION OF THE DRAWINGS

The accompanying drawings, wherein like reference numerals are employed to designate like components, are included to provide a further understanding of multi-conference stream mixing, are incorporated in and constitute a part of this specification, and illustrate embodiments of multi-conference stream mixing that together with the description serve to explain the principles of multi-conference stream mixing.

In the drawings:

FIG. 1 illustrates an embodiment of a multi-conference mixing method;

FIG. 2 illustrates an embodiment of a multi-conference mixing system;

FIG. 3 illustrates an embodiment of a multi-conference mixer operation;

FIG. 4 illustrates an embodiment of a mixing device;

FIG. 5 illustrates a network in which an embodiment of multi-conference mixing may take place;

FIG. 6 illustrates an embodiment of a one-to-one conferencing system; and

FIG. 7 illustrates an embodiment of a single mixer conferencing system.

### DETAILED DESCRIPTION

Reference will now be made to embodiments of multi-conference stream mixing, examples of which are illustrated in the accompanying drawings. Details, features, and advantages of multi-conference stream mixing will become further apparent in the following detailed description of embodiments thereof.

Any reference in the specification to “one embodiment,” “a certain embodiment,” or a similar reference to an embodiment is intended to indicate that a particular feature, structure or characteristic described in connection with the embodiment is included in at least one embodiment of the invention. The appearances of such terms in various places in the specification are not necessarily all referring to the same embodiment. References to “or” are furthermore intended as inclusive so “or” may indicate one or another of the ored terms or more than one ored term.

Network based conferencing is increasing in use in the conferencing market and is often conducted with participants communicating simultaneously over public or private telephone networks and public or private digital or computer networks such as the Internet. Those telephone and digital communications are often communicated using, in part or in whole, Internet Protocol (IP) based packets. The Internet Protocol (IP) is defined by the Internet Engineering Task Force (IETF) standard 5, Request for Comment (RFC) 791 (referred to as the “IP Specification”), adopted in September, 1981 and available from www.ietf.org. Conversion of non-IP based information to IP based information may be performed, as is known in the conferencing technologies, by gateways or otherwise; Development of conferencing technology that enhances established technologies and works well with those technologies may provide useful extensions of those broadly known and accepted technologies.

Use of compressed digital video in remote conferencing has become more accepted, practical, and affordable with the advent of digital transmission technology advances. Compressed digital video, for example, may be transmitted over various networks such as, for example, the Internet, Wide Area Networks (WANs) and Local Area Networks (LANs) with audio. Those digital video and audio transmissions are typically transmitted across such a network in one or more IP packets and further advance the practicality and economy of remote conferencing.

Mixing of audio and/or video streams, which may be referred to as conference streams, is an important operation in most conferencing systems. Such stream mixing is generally carried out with a spatial architecture, wherein a mixer is dedicated to each sub-conference that is occurring in a separate location. Thus, in such a system, as the number of sub-conferences increases, the number of mixers increases correspondingly at a one-to-one ratio. Moreover, those mixers are often physically located at each sub-conference location so that assistance from a person familiar with the operation of conferencing systems and mixers may be desirable at each physical sub-conference location.

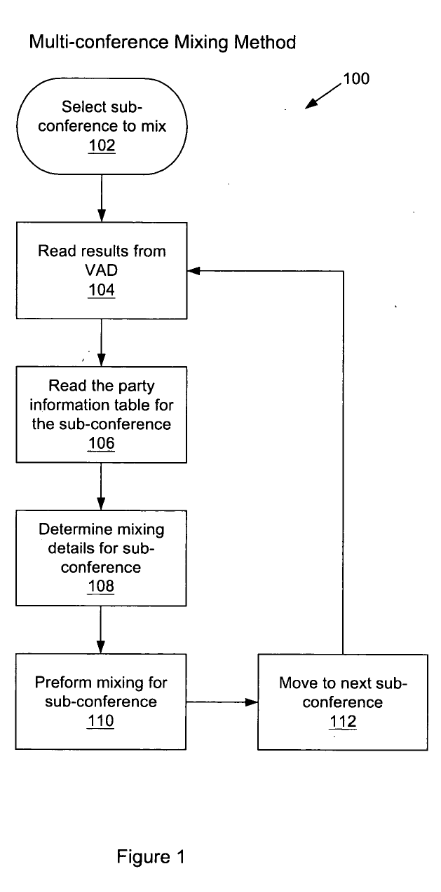

FIG. 1 illustrates an embodiment of a multi-conference mixing method 100. In addition, systems and apparatuses of distributing processing elements of a multimedia system and dynamic configuration of conferencing streams are provided herein. When processing is so distributed, multiple sub-conference locations may be operated through a single mixer or fewer mixers than there are sub-conferences. Moreover, that mixer or those mixers may be operated such that attributes of stream mixing for each sub-conference may be separately controlled. For example, if participants in a particular sub-conference wish to adjust the volume of audio they are receiving during a multi-media conference, the volume for that particular sub-conference may be modified without affecting other sub-conferences. The mixer may furthermore be reconfigurable dynamically, while a conference is in progress, to allow, for example, changes in the number of streams to be transmitted in the conference while the conference is ongoing.

The multi-conference mixer may process streams for each sub-conference sequentially until all sub-conference streams are processed for each cycle, or frame, of each sub-conference. The multi-conference mixer may be dynamically configurable as to both attributes for each existing sub-conference stream and each added or deleted sub-conference stream. Information regarding existing, added, and deleted sub-conferences and attributes of those sub-conferences may be stored in a party information table from which the mixer will draw information on which to base the various sub-conference streams that it is mixing. Thus, by changing the information in the party information table, whether directly or remotely from, for example, one or more of the sub-conferences, mixer operation may be dynamically changed during a conference.

For example, in a multimedia conference for distance learning, a professor may divide a conference of 500 students into discussion groups of approximately 10 students each, with each discussion group comprising a sub-conference. In a configuration wherein a mixer is required for each sub-conference, such a conference would require 50 mixers. The set up and management of such a large number of mixers may require significant resources and be inefficient to operate. That one-to-one mixer approach may also prove to be inflexible with regard to the addition or deletion of sub-conferences.

Recognizing that mixer operation at each sub-conference may be and is typically the same, recognizing that the number of active speakers in a conference is typically small because many simultaneous speakers cause the conversation in the conference to be unintelligible, and recognizing that processors and digital signal processors used in mixing have become more powerful, it may be possible and efficient, both in equipment cost and labor to set-up conferencing, to utilize a single mixer to support a 50 location conference such as the distance learning conference described above. That approach makes a distinction between a mixer and mixing operations, such that instead of creating multiple mixers for each sub-conference, the multi-conference mixer approach uses mixer operations from a single mixer device to support multiple sub-conferences.

The multi-conference mixing method 100 mixes streams for at least two sub-conferences. Each sub-conference may be mixed sequentially, so that streams for a first sub-conference may be mixed at a particular time slot, streams for a second sub-conference may be mixed in a following time slot, and so on until all sub-conference streams have been mixed.

Streams are often mixed based on frames, wherein a frame may be associated with a single video image in a series of video images, and audio that is contemporaneous with that frame. The specific mixing operation for each party in each processing frame may be determined by considering, for example, results of voice activity analysis by the voice activity detector, settings from the party information table for that sub-conference, and whether additional streaming needs to be added to that sub-conference, which may also be available from the party information table.

At 102, a sub-conference to be mixed during the current time slot is selected. At 104, results are read from the video activity detector so that the method may determine which parties are speaking and include the speaking party's streams in the mix for the current sub-conference. The party information table may be read at 106 to retrieve parameters for mixing of the current sub-conference and at 108, the streams, video activity results, and mixing parameters may be used in conjunction to select information to be transmitted to the current sub-conference. Such information may, for example, be audio and/or video information and may be referred to as conference information. At 110, a mix for the current sub-conference is created and transmitted to the sub-conference. At 112, the sub-conference to be mixed in the next time slot is selected and the multi-conference mixing method 100 is repeated for that sub-conference.

An embodiment of an article of manufacture may include a computer readable medium having stored thereon instructions which, when executed by a single processor, cause the processor to mix data streams for at least a first sub-conference and a second sub-conference participating in a conference. In an embodiment, the computer readable medium may also include instructions that cause the processor to process a plurality of conference streams sequentially based on audio received from a voice activity detector and attributes retrieved from a party information table stored in a storage device.

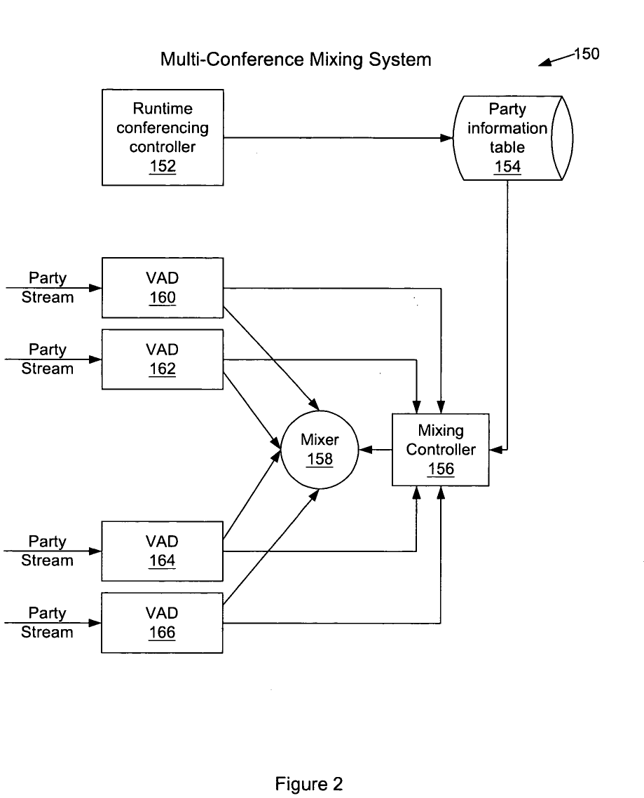

FIG. 2 illustrates an embodiment of a multi-conference mixing system 150. The multi-conference mixing system 150 illustrates four voice activity detectors 160, 162, 164, and 166 receiving party streams from sub-conferences (not shown), however it should be recognized that a single voice activity detector device may be utilized to detect voice or other audio activity for multiple party streams and so, voice activity detectors 160, 162, 164, and 166 may operate as a single device. A runtime conferencing controller 152 receives conferencing information from sub-conferences or other sources and places that information in appropriate format in the party information table 154. That conferencing information may include settings from remote sub-conferencing nodes such as settings related to how the conference is to be presented at those sub-conferencing nodes and provide warnings when changes are made to settings. The runtime conferencing controller 152 may also restrict access to authorized users, encrypt or decrypt messages containing the information to preserve confidentiality of data exchanged, and provide other security features to allow an operator to restrict access to the local party information table 154 or runtime conferencing controller 152.

A mixing controller 156 may receive video activity detector results from the video activity detector or detectors 160-166 and consult the party information table 154 to determine what streams are to be mixed and how they are to be transmitted to the sub-conferences. That information may then be transferred from the mixing controller 156 to a mixer 158. The mixer 158 may also receive the streams or portions of streams to be transmitted and use those streams along with the information received from the mixing controller 156 to mix streams for each sub-conference to which the mixer 158 is coupled.

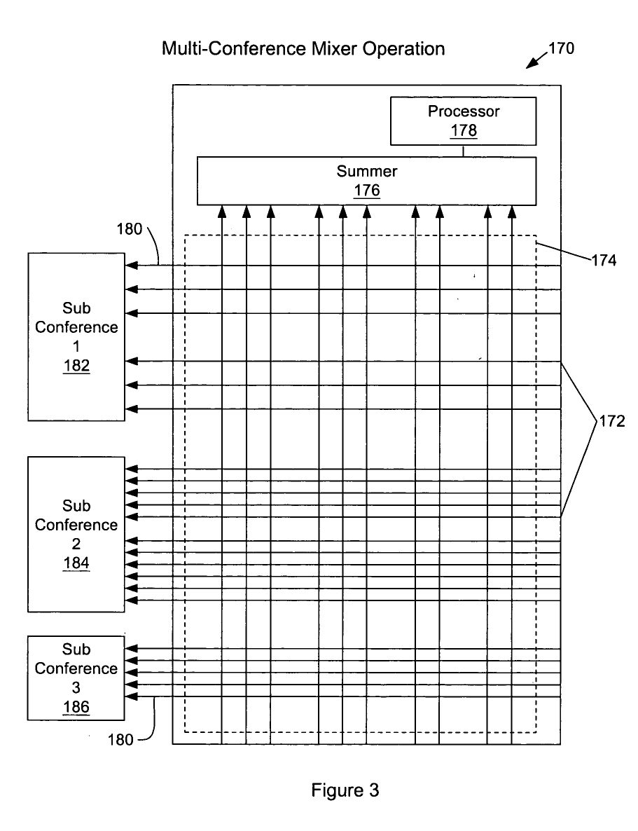

FIG. 3 illustrates an embodiment of a multi-conference mixer operation 170 that may be performed by, for example, the mixer 158 illustrated in FIG. 2. Party streams, such as audio and video transmitted from various sub-conferences, may be received at mixer inputs 172. The party streams are received by a switching matrix 174 from which the party streams may be directed to a summer 176 that combines streams. The combination of streams at the summer 176 may be controlled by a processor 178 that determines which party streams should be mixed for each sub-conference. The processor 178 may further communicate with a mixing controller such as the mixing controller 156 of FIG. 2, or may operate as the mixing controller 156. The processor 178 may thus receive information regarding stream mixing desired at the sub-conferences from a party information table such as the party information table illustrated 154 in FIG. 2. The mixed streams may then be output from mixer outputs 180 to various sub-conferences such as sub-conference 1 182, sub-conference 2 184, and sub-conference 3 186.

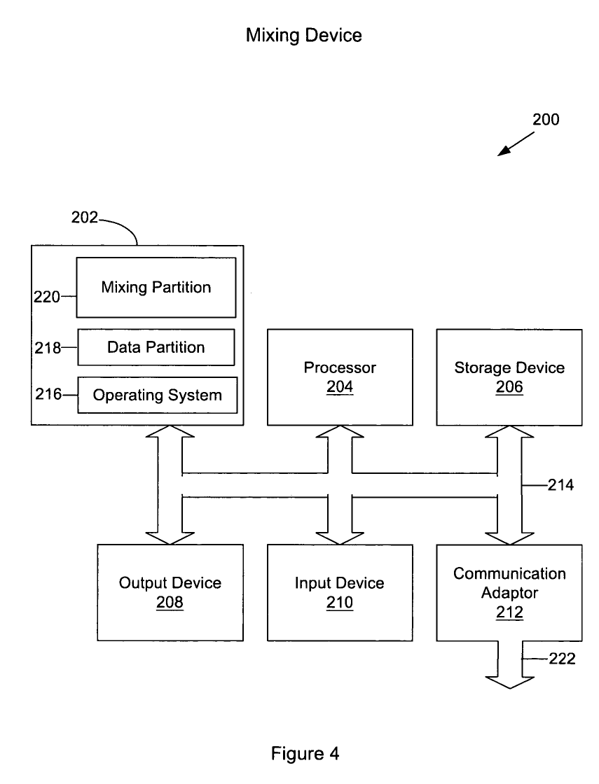

FIG. 4 illustrates an embodiment of a mixing device 200. The mixing device 200 includes memory 202, a processor 204, a storage device 206, an output device 208, an input device 210, and a communication adaptor 212. It should be recognized that any or all of the components 202-212 of the mixing device 200 may be implemented in a single machine. For example, the memory 202 and processor 204 might be combined in a state machine or other hardware based logic machine.

Communication between the processor 204, the storage device 206, the output device 208, the input device 210, and the communication adaptor 212 may be accomplished by way of one or more communication busses 214. It should be recognized that the mixing device 200 may have fewer components or more components than shown in FIG. 4. For example, if output devices 208 or input devices 210 are not desired, they may not be included with the mixing device 200.

The memory 202 may, for example, include random access memory (RAM), dynamic RAM, and/or read only memory (ROM) (e.g., programmable ROM, erasable programmable ROM, or electronically erasable programmable ROM) and may store computer program instructions and information. The memory 202 may furthermore be partitioned into sections including an operating system partition 216, wherein instructions may be stored, a data partition 218 in which data may be stored, and a mixing partition 220 in which instructions for mixing conferencing information and stored information related to such mixing may be stored. The mixing partition 220 may also allow execution by the processor 204 of the instructions to perform the instructions stored in the mixing partition 220. The data partition 218 may furthermore store data to be used during the execution of the program instructions such as, for example, a party information table containing mixing attributes for each sub-conference and information related to sub-conferencing nodes in the network.

The processor 204 may execute the program instructions and process the data stored in the memory 202. In one embodiment, the instructions are stored in memory 202 in a compressed and/or encrypted format. As used herein the phrase, “executed by a processor” is intended to encompass instructions stored in a compressed and/or encrypted format, as well as instructions that may be compiled or installed by an installer before being executed by the processor 204.

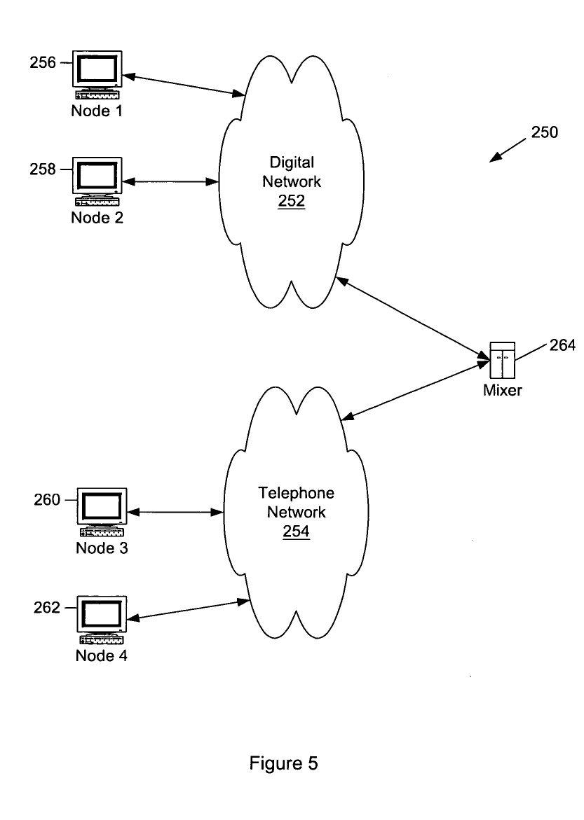

The storage device 206 may, for example, be a magnetic disk (e.g., floppy disk and hard drive), optical disk (e.g., CD-ROM) or any other device or signal that can store digital information. The communication adaptor 212 may permit communication between the mixing device 200 and other devices or nodes coupled to the communication adaptor 212 at a communication adaptor port 222. The communication adaptor 212 may be a network interface that transfers information from nodes on a network such as the network 250 illustrated in FIG. 5, to the mixing device 200 or from the mixing device 200 to nodes on the network. The network in which the mixing device 200 operates may alternately be, for example, a LAN, WAN, or the Internet. It will be recognized that the mixing device 200 may alternately or in addition be coupled directly to one or more other devices through one or more input/output adaptors (not shown).

The mixing device 200 may also be coupled to one or more output devices 208 such as, for example, a monitor or printer, and one or more input devices 210 such as, for example, a keyboard or mouse. It will be recognized, however, that the mixing device 200 does not necessarily need to have any or all of those output devices 208 or input devices 210 to operate.

The elements 202, 204, 206, 208, 210, and 212 of the mixing device 200 may communicate by way of one or more communication busses 214. Those busses 214 may include, for example, a system bus, a peripheral component interface bus, and an industry standard architecture bus.

Digital networks, such as the Internet, a LAN or a WAN and telephone transmission may be used for transmission of conferencing streams. Embodiments of the multi-conference mixer may operate independent of the type or types of networks on which the conferencing streams are transmitted. The transmissions may all converge to IP packets from TDM or other types of transmissions by way of, for example, a gateway that performs such conversion. Time Division Multiplexing, or TDM, is a method by which digital information may be transmitted over, for example, a Public Switched Telephone Network (PSTN). A PSTN is a collection of networks operated, for the most part, by telephone companies and administrational organizations. Internet Protocol, or IP, is a packet based protocol for use with, for example, X.25, frame-relay, and cell-relay based networks. The Internet Protocol is defined by the Internet Engineering Task Force (IETF) standard 5, Request for Comment (RFC) 791 (referred to as the “IP Specification”), adopted in September, 1981 and available from www.ieff.org.

Packets, such as IP packets, may be sent across a network, possibly by a variety of routs and, sometimes, with certain packets taking a discernable interval of time to arrive at a receiving entity such as the mixer 158 of FIG. 2. The receiving entity arranges the packets back into the transmitted information periodically, for example, once all packets are received or each time the next packet of streaming type information is received and then may operate on that information in the order in which that information is to be reconstructed.

A network in which multi-conference mixing may be implemented may be a network of nodes such as multimedia conferencing nodes, computers, telephones, or other, typically processor-based, devices interconnected by one or more forms of communication media. The communication media coupling those devices may include, for example, twisted pair, co-axial cable, optical fibers and wireless communication methods such as use of radio frequencies.

Network nodes may be equipped with the appropriate hardware, software or firmware necessary to communicate information in accordance with one or more protocols. A protocol may comprise a set of instructions by which the information is communicated over the communications medium. Protocols are, furthermore, often layered over one another to form something called a “protocol stack.”

In one example of a digital network, the network nodes operate in accordance with a modified seven layer Open Systems Interconnect (“OSI”) architecture. The OSI architecture includes (1) a physical layer, (2) a data link layer, (3) a network layer, (4) a transport layer, (5) a session layer, (6) a presentation layer, and (7) an application layer.

The physical layer is concerned with electrical and mechanical connections to the network and may, for example, be performed by a token ring or Ethernet bus in a standard OSI architecture. The data link layer arranges data into frames to be sent on the physical layer and may receive frames. The data link layer may receive acknowledgement frames, perform error checking and re-transmit frames not correctly received. The data link may also be performed by the bus handling the physical layer.

The network layer determines routing of packets of data and may be performed by, for example, Internet Protocol (IP). The transport layer establishes and dissolves connections between nodes. The transport layer function is commonly performed by a packet switching protocol referred to as the Transmission Control Protocol (TCP). TCP is defined by the Internet engineering Task Force (IETF) Standard 7, Request for Comment (RFC) 793, adopted in September, 1981 (the “TCP Specification”). The network and transport layers are often referred to collectively as “TCP/IP.”

In one embodiment of the invention, the network nodes utilize a packet switching protocol referred to as the User Datagram Protocol (UDP) as defined by the Internet Engineering Task Force (IETF) standard 6, Request For Comment (RFC) 768, adopted in August, 1980 (the “UDP Specification”) in connection with Internet Protocol (IP). The UDP Specification is also available from “www.ieff.org.”

The session layer establishes a connection between processes on different nodes and handles security and creation of the session. The presentation layer performs functions such as data compression and format conversion to facilitate systems operating in different nodes. The application layer is concerned with a user view of network data, for example, formatting electronic messages. In certain TCP/IP platforms, the functionality of the session layer, the presentation layer, and the application layer are all performed by the application.

FIG. 5 illustrates an embodiment of a network 250 in which teleconferencing may take place. The network may include a digital network 252 and a telephone network 254. The digital network 252 may include, for example, a Local Area Network (LAN), a Wide Area Network (WAN), or a public network such as the Internet. The telephone network 254 may include, for example, a Public Switched Telephone Network (PSTN) or a Private Branch Exchange (PBX).

The network 250 may include a first teleconferencing node 256 and a second tele conferencing node 258 coupled to the digital network 252. The network 250 may also include a third teleconferencing node 260 and a fourth teleconferencing node 262 coupled to the telephone network 254. In addition, a mixer 264 may be coupled to the digital network 252 and/or the telephone network 254 and may receive information transmitted from the teleconferencing nodes 256-262 and transmit data to the teleconferencing nodes 256-262.

The teleconferencing nodes 260 and 262 coupled to the telephone network 254 may, when transmitting streams, transmit TDM formatted information across the telephone network 254. That TDM formatted information may be converted to packet-based format by a gateway (not shown) and communicated to the mixer 264.

Information may comprise any data capable of being represented as a signal, such as an electrical signal, optical signal, acoustical signal and so forth. Examples of information in this context may include voice and acoustic data, graphics, images, video, text and so forth.

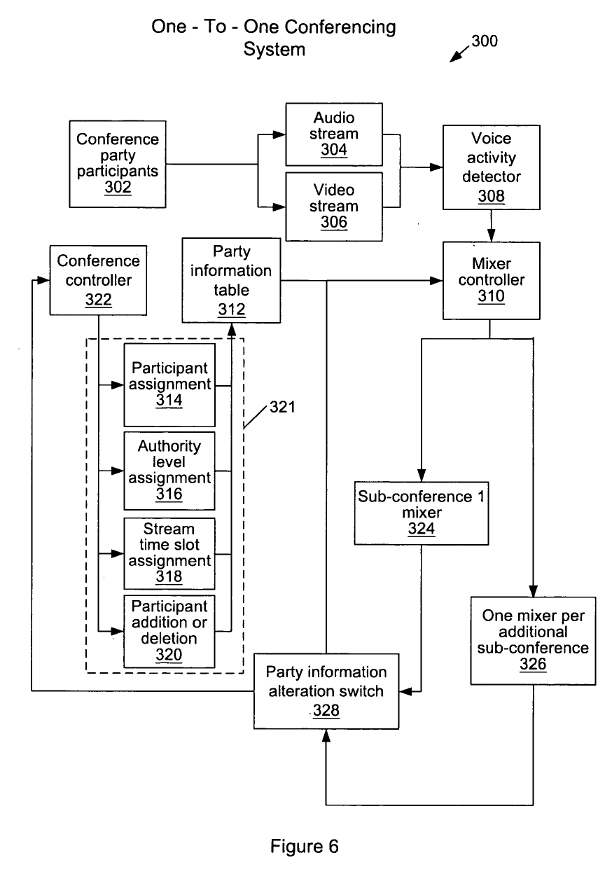

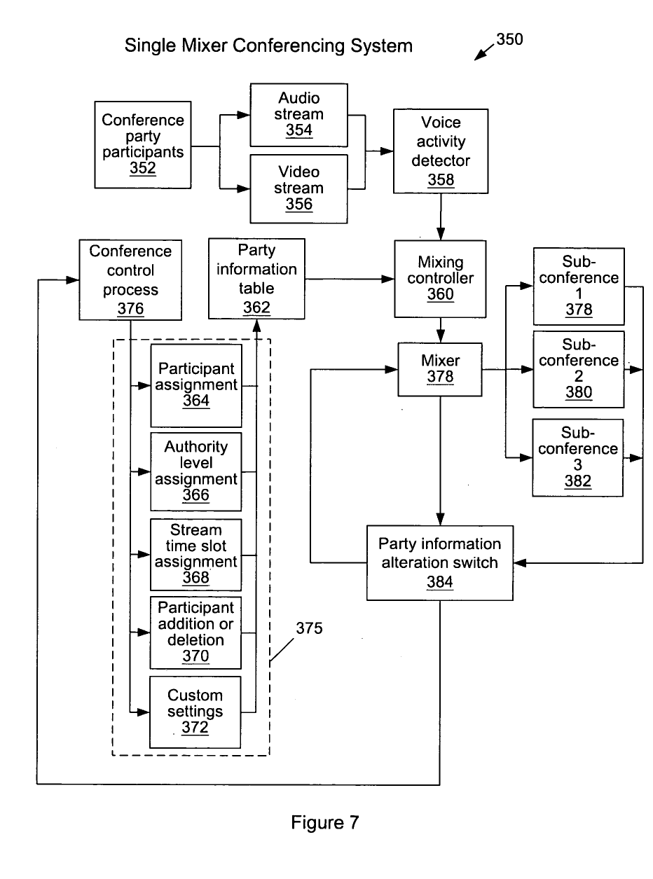

FIG. 6 illustrates an embodiment of a one-to-one conferencing system 300 in which a mixer is used for each conferencing location. Each conferencing location may be referred to herein as a “party.” The conferencing systems 300 and 350 illustrated in FIGS. 6 and 7 are typical of a centralized conferencing model, wherein all participants call in to a conferencing server containing one or more mixers that provide audio and/or video streams for all sub-conferences, but application is not limited to such a centralized conferencing model.

In the one-to-one conferencing system 300 conference party participants 302 transmit audio streams 304 and video streams 306 to a voice activity detector 308. The voice activity detector 308 may determine which party streams include audio. Those streams that include audio may be deemed active and audio and/or video from the active participants may be transmitted from the voice activity detector 308 to one or more of the conferencing parties. As for party participants that have inactive audio, audio and/or video from certain of those party participants may be transmitted from the voice activity detector 308 to one or more of the conferencing parties while other inactive party participant streams may not be transmitted to party participants. For example, where a certain party participant is making a presentation, audio and/or video from that party participant may be transmitted even if that party participant's audio is inactive so that, for example, visual aids used by that presenting party participant can be viewed by all sub-conferences at all times. Audio and video streams from another party participant that is not presenting may, however, not be transmitted unless the audio stream from that party participant indicates the party participant is speaking to the conference party participants. Recognizing that in a conference, typically few participants are talking at any given time, by not transmitting audio or video for sub-conference nodes where no participants are speaking, the amount of information that is transmitted may be reduced a great deal over a system wherein information from all participants is transmitted even when they are not speaking or otherwise active.

A mixing controller 310 receives the conferencing streams, or a portion of those streams to be transmitted. The mixing controller 310 also may receive party information from a party information table 312 that provides information regarding how the streams are to be mixed for each party participant. The mixing controller 310 may combine and synchronize audio and/or video streams to be transmitted to the party participants in accordance with the party information table 312.

The party information table 312 may include information such as addresses of participating sub-conference nodes, settings for streams being transmitted to sub-conference nodes, such as audio volume, authority levels for the participating sub-conference nodes, and assignment of time slots during which incoming and outgoing streams are to be processed.

The party information table 312 may receive inputs from a conference controller 322. The conference controller 322 may, in turn, receive inputs from party participants through their respective sub-conference nodes and may alternately or in addition receive direct input from a person or machine that is managing the conference. The conference controller 322 may then place control information in the party information table 312 in accordance with those inputs. Control information 321 may be processed and passed from the conference controller 322 to the party information table 312. That control information may include, for example, information such as addresses at participant assignment 314 of participating sub-conference nodes that are assigned to the conference to provide conferencing to party participants, authority levels at authority level assignment 316 for the participating sub-conference nodes from which determinations may be made regarding, for example, conflicting settings received from various participating sub-conference nodes or the priority of transmissions to the participating sub-conference nodes, assignment of time slots 318 during which incoming and outgoing streams are to be processed, and information regarding the addition or deletion of additional conferencing nodes 320 to the conference.

The conference controller 322 may provide or restrict control exercised by party participants or non-participants as desired. The conference controller 322 may also encrypt and decrypt messages being passed between it and the sub-conferences to maintain confidentiality. Moreover, the conference controller 322 may provide warnings when changes are made to conference settings.

A mixer 324 is provided for a main sub-conference that includes, for example, a primary presenter for the conference. An additional mixer 326 is also provided for every other sub-conference. A party information alteration switch 328 may be provided to transmit changes in control information from one or more parties to the conference controller 322, which may format and place that information in the party information table 312 to be read by the mixing controller 310. Where no changes have been mad to the control information, the party information alteration switch 328 may directly return control to the mixing controller 310 to mix additional streams in accordance with current control information. It should be noted that alterations to control information might be communicated in various ways including transmitting new control information to the conference controller 322 from time to time and separately having the party information table 312 communicate control information to the mixing controller 310 periodically or when triggered by a change in control information.

FIG. 7 illustrates an embodiment of a single mixer conferencing system 350 in which a single mixer is used for all conferencing locations. Multiple mixers may be used in certain embodiments, particularly those having a large number of sub-conference locations, the significance of that embodiment is thus that more than one sub-conference location is handled by a single mixer.

In the single mixer conferencing system 350 conference party participants 352 transmit audio streams 354 and video streams 356 to a voice activity detector 358. The voice activity detector 358 may determine which party streams include audio. Those streams that include audio may be deemed active and audio and/or video from the active participants may be transmitted out to one or more of the conferencing parties. As for party participants that have inactive audio, audio and/or video from certain of those party participants may be transmitted out to one or more of the conferencing parties while other inactive party participant streams may not be transmitted to party participants.

A mixing controller 360 receives the conferencing streams, or a portion of those streams to be transmitted. The mixing controller 360 also may receive party information from a party information table 362 that provides information regarding how the streams are to be mixed for each party participant. The mixing controller 360 may then determine how to combine and synchronize audio and/or video streams to be transmitted to two or more sub-conference nodes in accordance with the party control table 362.

The party information table 362 may include information such as addresses of participating sub-conference nodes, settings for streams being transmitted to sub-conference nodes, authority levels for the participating sub-conference nodes, and assignment of time slots during which incoming and outgoing streams are to be processed. The party information table may furthermore provide for customized audio and video streams for each participating sub-conference node.

The party information table 362 may receive inputs from a conference controller 376. The conference controller 376 may receive inputs from party participants through their respective sub-conference nodes and may alternately or in addition receive direct input from a person or machine that is managing the conference. The conference controller 376 may then place control information 375 in the party information table 362 in accordance with those inputs. Control information 375 typically passed from the conference controller 376 to the party information table 362 and may include information such as addresses at participant assignment 364 of participating sub-conference nodes, authority levels at authority level assignment 366 for the participating sub-conference nodes, assignment of time slots for sub-conferences 368, information regarding the addition or deletion of additional sub-conferencing nodes 370 to the conference, and customized adjustment of settings 372 such as audio properties on a per sub-conference basis.

A mixer 378 is provided that mixes streams for a first sub-conference and at least one other sub-conference. As illustrated, the mixer 378 is providing audio and video streams to the first sub-conference 378 and two additional sub-conferences 380 and 382. At 384, adjustments made from each sub-conference are transmitted to the conference controller 376.

While the systems, apparatuses, and methods of multi-conference mixing have been described in detail and with reference to specific embodiments thereof, it will be apparent to one skilled in the art that various changes and modifications can be made therein without departing from the spirit and scope thereof. Thus, it is intended that the modifications and variations be covered provided they come within the scope of the appended claims and their equivalents.

1. A mixer, comprising a single processor to couple to two sub-conference nodes, to select at least a portion of information received from the two sub-conference nodes, and to transmit that selected portion of information to the two sub-conference nodes.

2. The mixer of claim 1, wherein the portion of information transmitted to the first sub-conference and the portion of information transmitted to the second sub-conference are selected sequentially by the processor.

3. The mixer of claim 1, wherein the portion of information transmitted to the first sub-conference is selected by the processor based on an attribute received from the first sub-conference.

4. The mixer of claim 3, wherein the portion of information transmitted to the first sub-conference is modified by the processor and the portion of information transmitted to the second sub-conference is unmodified based on a change in the attribute received from the first sub-conference.

5. The mixer of claim 1, wherein the portion of information transmitted to the first sub-conference is selected by the processor based on audio activity sensed at the first and second sub-conferences.

6. The mixer of claim 1, wherein a third sub-conference node is coupled to the single processor during a conference and the single processor selects at least a portion of information received from the three sub-conference nodes, and transmits that selected portion of information to the three sub-conference nodes.

7. A mixer, comprising:
an input to couple to at least two sub-conference nodes;
an output to couple to the at least two sub-conference nodes;
a storage device to contain attributes of each sub-conference node; and
a single processor coupled to the input, the output, and the storage device to format information incident at the input, and output at least a portion of that information at the output in accordance with the attributes.

8. The mixer of claim 7, further comprising a voice activity detector coupled to the sub-conference nodes and the input to provide conference information from at least one of the sub-conference nodes to the mixer if audio activity is detected at the at least one sub-conference node.

9. The mixer of claim 8, wherein conference information is not provided at the output for at least one of the sub-conference nodes when audio activity is not detected by the voice activity detector from that sub-conference node.

10. The mixer of claim 7, wherein the attributes are stored in a party information table.

11. The mixer of claim 7, wherein the storage device is random access memory.

12. The mixer of claim 7, wherein the storage device is a magnetic disk.

13. The mixer of claim 7, further comprising a second processor communicating with the storage device to vary attributes contained in the storage device.

14. A stream mixing method, comprising mixing data streams for at least a first sub-conference and a second sub-conference participating in a conference in a single mixer.

15. The stream mixing method of claim 14, further comprising changing the number of data streams mixed by the mixer while the conference is in progress.

16. The stream mixing method of claim 14, wherein changing the number of data streams includes adding a data stream for an additional sub-conference.

17. The stream mixing method of claim 14, further comprising modifying an attribute of the first sub-conference without modifying an attribute of the second sub-conference while the conference is in progress.

18. The stream mixing method of claim 17, wherein modifying an attribute of the first sub-conference includes modifying the audio volume at the first sub-conference without modifying the audio volume of the second sub-conference, while the conference is in progress.

19. The stream mixing method of claim 14, wherein the data stream for the first sub-conference and the data stream for the second sub-conference are processed sequentially by the mixer.

20. The stream mixing method of claim 14, wherein information as to how the streams for the first and second sub-conferences are to be mixed is stored in a data storage device.

21. The stream mixing method of claim 20, wherein the data storage device is random access memory.

22. The stream mixing method of claim 20, wherein the information as to how streams are to be mixed is modified during the conference.

23. An article of manufacture, comprising:
a computer readable medium having stored thereon instructions which, when executed by a single processor, cause the processor to mix data streams for at least a first sub-conference and a second sub-conference participating in a conference.

24. The article of manufacture of claim 23, wherein the computer readable medium includes instructions which, when executed by the single processor, cause the single processor to mix the data streams for the first sub-conference and the second conference sequentially.

25. The article of manufacture of claim 23, wherein the computer readable medium includes instructions which, when executed by the single processor, cause the single processor to select information to be included in the data streams based on receipt of audio information from the first sub-conference and the second sub-conference as indicated by a voice activity detector at an input to be coupled to the processor.

26. The article of manufacture of claim 23, wherein the computer readable medium includes instructions which, when executed by the single processor, cause the single processor to format information to be included in the data streams based on attributes to be retrieved by the processor from a storage device to be coupled to the processor.
